(19) United States
(12) Patent Application Publication
(10) Pub. No.: US 2023/0279556 A1
(43) Pub. Date: Sep. 7, 2023

(54) ELECTROLYSIS CELL SYSTEM AND METHOD FOR PREPARING HYDROGEN AND OXYGEN

(71) Applicant: GUANGDONG HORIZON RUILONG NEW ENERGY TECHNOLOGIES CO., LTD., Foshan City (CN)

(72) Inventors: Arthur Ernest Koschany, Suzhou (CN); Liqin Zhou, Suzhou (CN); Jun Zhai, Suzhou (CN)

(21) Appl. No.: 17/956,972

(22) Filed: Sep. 30, 2022

(30) Foreign Application Priority Data
Mar. 1, 2022 (CN) 2022101950716

(51) Int. Cl. C25B 1/02; C25B 11/065; C25B 11/081; C25B 9/19; C25B 11/042; C25B 15/08; C25B 13/00

(52) U.S. Cl. CPC C25B 1/02; C25B 11/065; C25B 11/081; C25B 9/19; C25B 11/042; C25B 15/08; C25B 13/00

(57) ABSTRACT

Disclosed are an electrolysis cell system and a method for preparing hydrogen and oxygen. The electrolysis cell system includes: an anode chamber with an inlet and an outlet; a cathode chamber with an inlet and an outlet; a composite membrane electrode set between the anode chamber and the cathode chamber, which includes a cation exchange membrane in alkali-ion form with an anode catalyst coated on one side thereof and a cathode catalyst coated on the other side thereof; a continuous or intermittent flow of an aqueous alkaline electrolyte through the anode chamber and the cathode chamber. The electrolysis cell system of the present disclosure features low material cost, long membrane service life, high operating temperature, low operating requirements and high safety; when it is used to prepare hydrogen and oxygen, gas with relatively high purity can be obtained.

### CROSS-REFERENCE TO RELATED APPLICATIONS

This patent application claims the benefit and priority of the Chinese Patent Application No. CN 202210195071.6 filed on Mar. 1, 2022. The entire disclosure of the above application is incorporated herein by reference.

### FIELD

The present disclosure relates to an electrolysis cell system and a method for preparing hydrogen and oxygen.

### INTRODUCTION

The use of an acidic cation exchange membrane in a form of H⁺ for PEM electrolysis has the following disadvantages that an extremely expensive iridium-containing catalyst is required; the plate material of an anode for an oxidation reaction must be titanium, and an expensive iridium coating is required.

The use of an anion exchange membrane for alkaline electrolysis has the following disadvantages that the membrane has a short service life, and the operating temperature is low.

When a porous separator is used for alkaline electrolysis, the pressure difference between hydrogen and oxygen chambers must be controlled very carefully to avoid gas mixing. In addition, bubbles generated in an electrolyte deteriorate the conductivity of the gap between an electrode and the porous separator.

The application U.S. Pat. No. 8,936,704B1 discloses a technology for preparing hydrogen by electrolysis with an adjustable operating capacity, which relates to a low gas purity of a liquid alkaline electrolyte at a low load, posing a hidden danger of explosion.

### SUMMARY

The technical problem to be solved in the present disclosure is to overcome defects in the prior art, including the use of precious metal materials, short membrane service life, low operating temperature, high operating requirements and low safety, thereby providing an electrolysis cell system and a method for preparing hydrogen and oxygen. The electrolysis cell system of the present disclosure features low material cost, long membrane service life, high operating temperature, low operating requirements and high safety; when used in the preparation of hydrogen and oxygen, it can obtain gas with relatively high purity.

The present disclosure solves the above-mentioned technical problem through the following technical solutions:

The present disclosure provides an electrolysis cell system, wherein the electrolysis cell system includes:
an anode chamber with an inlet and an outlet;
a cathode chamber with an inlet and an outlet;
a composite membrane electrode set between the anode chamber and the cathode chamber, which includes a cation exchange membrane in alkali-ion form with an anode catalyst coated on one side and a cathode catalyst coated on the other side;
a continuous or intermittent flow of an aqueous alkaline electrolyte through the anode chamber and the cathode chamber.

In the present disclosure, the cation exchange membrane in alkali-ion form is preferably a perfluorinated sulfonic acid membrane in alkali-ion form, further preferably a perfluorinated sulfonic acid membrane in sodium-ion form or a perfluorinated sulfonic acid membrane in potassium-ion form, e.g. a perfluorinated sulfonic acid membrane in sodium-ion form (PFSA-Na). The perfluorinated sulfonic acid membrane is a copolymer with polytetrafluoroethylene as the main chain, a sulfonic acid group as the end group, and perfluorinated vinyl ether as the side chain.

In the present disclosure, the thickness of the cation exchange membrane in alkali-ion form is preferably 8-170 μm, further preferably 15-60 μm, e.g. 50 μm.

In the present disclosure, the equivalent weight (EW) of the cation exchange membrane in alkali-ion form is preferably 700-1,500, further preferably 900-1,100. Wherein the equivalent weight is defined as the weight of the cation exchange membrane in alkali-ion form containing 1 mol of sulfonic acid groups with alkali ions, with a unit of g/mol.

In the present disclosure, the anode catalyst includes conventional transition metals in the art, and preferably includes one or more of Mn, Fe, Co, Ni and Cu, such as stainless steel or nickel powder.

In the present disclosure, the cathode catalyst is preferably a nickel catalyst, more preferably nickel with a high surface area; preferably, the amount of the nickel catalyst is 10 mg/cm².

In the present disclosure, the cathode catalyst can also be a Pt/C catalyst; preferably, the loading of the Pt/C catalyst is 0-0.25 mg/cm² rather than 0, more preferably 0.09 mg/cm² or 0.2 mg/cm².

In the present disclosure, the aqueous alkaline electrolyte is preferably an alkali metal hydroxide solution, further preferably a NaOH aqueous solution or a KOH aqueous solution, e.g. the NaOH aqueous solution.

Wherein, the inlet concentration of the NaOH aqueous solution can be 1-15 mol/L, preferably 2.5-4 mol/L. At a low current density, the concentration of the NaOH aqueous solution remains stable by means of reverse diffusion through the membrane; at a high current density, however, the inlet concentration of the NaOH aqueous solution must be controlled, so as to balance the concentration difference outside the battery, and prevent a voltage increase caused by great changes in the concentration of the NaOH aqueous solution during electrolysis.

The present disclosure further provides a method for preparing hydrogen and oxygen, wherein, the electrolysis cell system is used to prepare hydrogen and oxygen by electrolysis, wherein hydrogen is discharged from the cathode chamber outlet, and oxygen is discharged from the anode chamber outlet.

Wherein, the aqueous alkaline electrolyte can be fed by the following method: mixing the aqueous alkaline electrolyte flowing out from the anode chamber outlet and the aqueous alkaline electrolyte flowing out from the cathode chamber outlet to obtain a mixed solution, and then passing the mixed solution into the anode chamber inlet and the cathode chamber inlet respectively, to enter the anode chamber and the cathode chamber.

Alternatively, passing the aqueous alkaline electrolyte flowing out from the anode chamber outlet into the cathode chamber inlet to enter the cathode chamber; and passing the aqueous alkaline electrolyte flowing out from the cathode chamber outlet into the anode chamber inlet to enter the anode chamber. In this case, the voltage of the electrolysis cell is relatively lower at a given current density.

Wherein, the operating temperature of the electrolysis cell system is preferably 80-150° C., further preferably 90-110° C.

On the basis of conforming to general knowledge in the art, the preferred conditions can be in any combination, i.e. obtaining preferred examples of the present disclosure.

All reagents and raw materials used in the present disclosure are commercially available.

The present disclosure achieves the following positive and progressive effects:
1. The electrolysis cell system of the present disclosure adopts a perfluorinated sulfonic acid membrane in alkali-ion form, characterized in high temperature stability. Moreover, the perfluorinated sulfonic acid membrane has a long service life, without attenuation due to a Fenton reaction like a fuel cell or a PEM electrolysis cell.
2. The electrolysis cell system of the present disclosure adopts inexpensive anode and cathode catalysts. The materials are inexpensive and cost-effective.
3. The electrolysis cell system of the present disclosure is used at a high operating temperature, which can be 80-150° C., with low operating requirements and high safety.
4. The method for preparing hydrogen and oxygen of the present disclosure can be used to prepare gas with relatively high purity.

### DRAWINGS

FIG. 1 is an operational view of an electrolysis cell system in Example 1.

FIG. 2 is a U/I curve of an electrolysis cell system in Example 1.

FIG. 3 is a U/I curve of an electrolysis cell system in Examples 4 and 5.

FIG. 4 is a graph of a relation between voltage (U) and temperature (T) at different current densities (I) of an electrolysis cell system in Examples 2-5.

FIG. 5 is a graph of a relation between U and T at different current densities of an electrolysis cell system in Examples 6-9.

FIG. 6 is a graph of a relation between U and T at different current densities of an electrolysis cell system in Examples 10-13.

FIG. 7 is a U/I curve at different NaOH concentrations of an electrolysis cell system in Examples 4, 8 and 12.

FIG. 8 is a U/I curve at different NaOH concentrations of an electrolysis cell system in Examples 5, 9 and 13.

FIG. 9 is a U/I curve of an electrolysis cell system in Example 5 and Comparative example 1.

### DESCRIPTION OF APPENDED DRAWING REFERENCE SIGNS

Anode chamber outlet 1;
Anode chamber 2;
Anode chamber inlet 3;
Cathode chamber outlet 4;
Cathode chamber 5;
Cathode chamber inlet 6;
Anode catalyst 7;
Cation exchange membrane in alkali-ion form 8;
Cathode catalyst 9.

### DETAILED DESCRIPTION

The present disclosure is further illustrated by the following examples without limiting thereto. Experimental methods without specific conditions indicated in the examples are selected according to conventional methods and conditions or instructions for use of commodities.

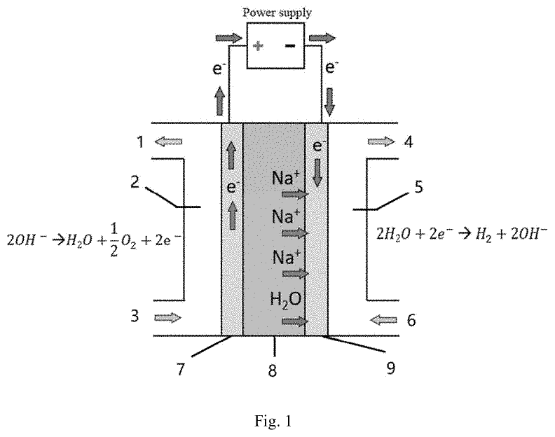

An electrolysis cell system in Examples 1-13 of the present disclosure is shown in FIG. 1, including an anode chamber 2, a cathode chamber 5 and a composite membrane electrode. The anode chamber 2 has an anode chamber outlet 1 and an anode chamber inlet 3; the cathode chamber 5 has an cathode chamber outlet 4 and an cathode chamber inlet 6; the composite membrane electrode is set between the anode chamber 2 and the cathode chamber 5; the composite membrane electrode includes an anode catalyst 7, cation exchange membrane in alkali-ion form 8 and a cathode catalyst 9, wherein the anode catalyst 7 and the cathode catalyst 9 is coated on both sides of the cation exchange membrane in alkali-ion form 8. An aqueous alkaline electrolyte continuously or intermittently flows through the anode chamber 2 and the cathode chamber 5.

The anode chamber inlet 3 and the cathode chamber inlet 6 are used for flow-in of the aqueous alkaline electrolyte; the anode chamber outlet 1 and the cathode chamber outlet 4 are used for flow-out of the aqueous alkaline electrolyte and discharges of gases.

The cation exchange membrane in alkali-ion form 8 in Examples 1-13 is a perfluorinated sulfonic acid membrane in sodium-ion form, with an equivalent weight of 1,100, a thickness of 50 μm and a surface area of 25 cm²⁻; 10 mg/cm² nickel powder is used as the anode catalyst 7 in Examples 1-13; Pt/C is used as the cathode catalyst 9, the loading of the cathode catalyst 9 is 0.09 mg/cm² in Example 1 or 0.2 mg/cm² in Examples 2-13.

### Example 1

A NaOH aqueous solution with a concentration of 3 mol/L was passed into an electrolysis cell from the anode chamber inlet 3 and the cathode chamber inlet 6 respectively. A power supply was connected for electrolysis at an operating temperature of 90° C. Hydrogen was discharged from the cathode chamber outlet 4, and oxygen was discharged from the anode chamber outlet 1. A NaOH aqueous solution flowing out from the anode chamber outlet 1 and a NaOH aqueous solution flowing out from the cathode chamber outlet 4 was mixed and then passed into the cathode chamber inlet 6 and the anode chamber inlet 3.

### Example 2

A NaOH aqueous solution with a concentration of 3 mol/L was passed into an electrolysis cell from the anode chamber inlet 3 and the cathode chamber inlet 6 respectively. A power supply was connected for electrolysis at an operating temperature of 70° C. Hydrogen was discharged from the cathode chamber outlet 4, and oxygen was discharged from the anode chamber outlet 1. A NaOH aqueous solution flowing out from the anode chamber outlet 1 and a NaOH aqueous solution flowing out from the cathode chamber outlet 4 was mixed and then passed into the cathode chamber inlet 6 and the anode chamber inlet 3.

### Example 3

A power supply was connected for electrolysis at an operating temperature of 80° C. and under the same other conditions as example 2.

### Example 4

A power supply was connected for electrolysis at an operating temperature of 90° C. and under the same other conditions as example 2.

### Example 5

A power supply was connected for electrolysis at an operating temperature of 100° C. and under the same other conditions as example 2.

### Example 6

A NaOH aqueous solution with a concentration of 5 mol/L was passed into an electrolysis cell from the anode chamber inlet 3 and the cathode chamber inlet 6 respectively. A power supply was connected for electrolysis at an operating temperature of 70° C. Hydrogen was discharged from the cathode chamber outlet 4, and oxygen was discharged from the anode chamber outlet 1. A NaOH aqueous solution flowing out from the anode chamber outlet 1 and a NaOH aqueous solution flowing out from the cathode chamber outlet 4 was mixed and then passed into the cathode chamber inlet 6 and the anode chamber inlet 3.

### Example 7

A power supply was connected for electrolysis at an operating temperature of 80° C. and under the same other conditions as example 6.

### Example 8

A power supply was connected for electrolysis at an operating temperature of 90° C. and under the same other conditions as example 6.

### Example 9

A power supply was connected for electrolysis at an operating temperature of 100° C. and under the same other conditions as example 6.

### Example 10

A NaOH aqueous solution with a concentration of 7.5 mol/L was passed into an electrolysis cell from the anode chamber inlet 3 and the cathode chamber inlet 6 respectively. A power supply was connected for electrolysis at an operating temperature of 70° C. Hydrogen was discharged from the cathode chamber outlet 4, and oxygen was discharged from the anode chamber outlet 1. A NaOH aqueous solution flowing out from the anode chamber outlet 1 and a NaOH aqueous solution flowing out from the cathode chamber outlet 4 was mixed and then passed into the cathode chamber inlet 6 and the anode chamber inlet 3.

### Example 11

A power supply was connected for electrolysis at an operating temperature of 80° C. and under the same other conditions as example 10.

### Example 12

A power supply was connected for electrolysis at an operating temperature of 90° C. and under the same other conditions as example 10.

### Example 13

A power supply was connected for electrolysis at an operating temperature of 100° C. and under the same other conditions as example 10.

### Comparative Example 1

Conventional PEM electrolysis and a system thereof in the art were adopted. The membrane was Nafion 1135, the anode catalyst was 1.5 mg/cm² IrO2, the cathode catalyst was 0.1 mg/cm² Pt/C, and the anode and the cathode of a gas diffusion layer were titanium fiber felt and carbon fiber cloth respectively.

### Effect Example 1

An electrolysis cell system in Examples 1-13 and Comparative example 1 was adopted. According to conditions in Examples 1-13 and Comparative example 1, the system was operated at different current densities, and voltage values were recorded, respectively.

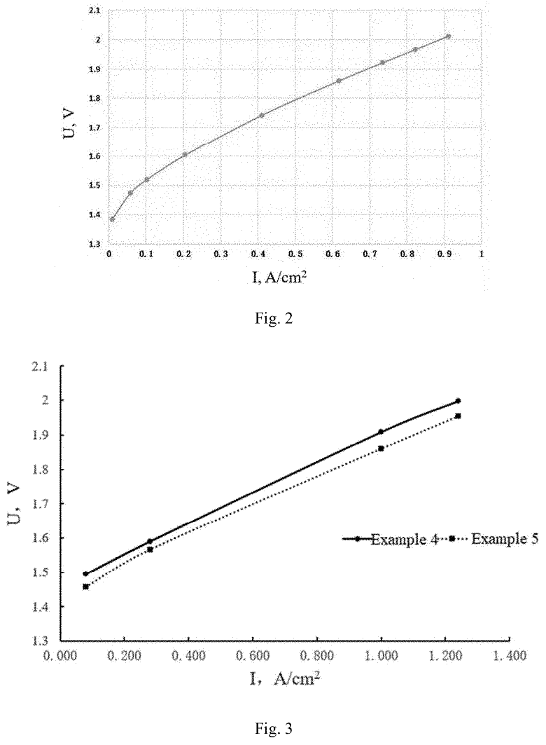

According to conditions in Example 1, the system was operated at different current densities, voltage values were recorded, and a U/I curve shown in FIG. 2 was obtained by means of plotting. FIG. 2 shows that voltages at both ends are relatively low in the electrolysis cell, and even at very low current densities, the membrane can separate hydrogen from oxygen without causing safety problems.

According to conditions in Examples 2-13, the system was operated at different current densities, and voltage values were recorded. Voltage and current value records in Examples 2-13 are shown in Table 1.

TABLE 1
Values of U and I at different operating temperatures
and different concentrations of NaOH aqueous solutions

| | Ex. 2 | Ex. 6 | Ex. 10 | Ex. 3 | Ex. 7 | Ex. 11 | Ex. 4 | Ex. 8 | Ex. 12 | Ex. 5 | Ex. 9 | Ex. 13 |
|---|---|---|---|---|---|---|---|---|---|---|---|---|
| | c, mol/L | | | | | | | | | | | |
| | 3 | 5 | 7.5 | 3 | 5 | 7.5 | 3 | 5 | 7.5 | 3 | 5 | 7.5 |
| I, A/cm² | U, V | | | | | | | | | | | |
| 0.080 | 1.532 | 1.549 | 1.547 | 1.494 | 1.507 | 1.509 | 1.462 | 1.472 | 1.47 | 1.457 | 1.437 | 1.436 |
| 0.280 | 1.692 | 1.714 | 1.713 | 1.635 | 1.647 | 1.655 | 1.589 | 1.601 | 1.594 | 1.566 | 1.561 | 1.556 |
| 1.000 | 2.199 | 2.153 | 2.202 | 2.004 | 2.027 | 2.056 | 1.908 | 1.950 | 1.963 | 1.859 | 1.875 | 1.891 |
| 1.240 | 2.264 | 2.298 | 2.353 | 2.111 | 2.145 | 2.179 | 1.997 | 2.045 | 2.075 | 1.953 | 1.966 | 1.993 |

According to conditions in Examples 4 and 5, the system was operated at different current densities, voltage values were recorded, and a U/I curve shown in FIG. 3 was obtained by means of plotting. FIG. 3 shows that in a 3 mol/L NaOH solution, the voltage at 100° C. is lower than that at 90° C., and the operating temperature is preferably 100° C. The higher the temperature, the better the operating performance of the electrolysis cell. Under a given operating pressure, the temperature is preferably slightly lower than the boiling point of a NaOH solution at a specified concentration.

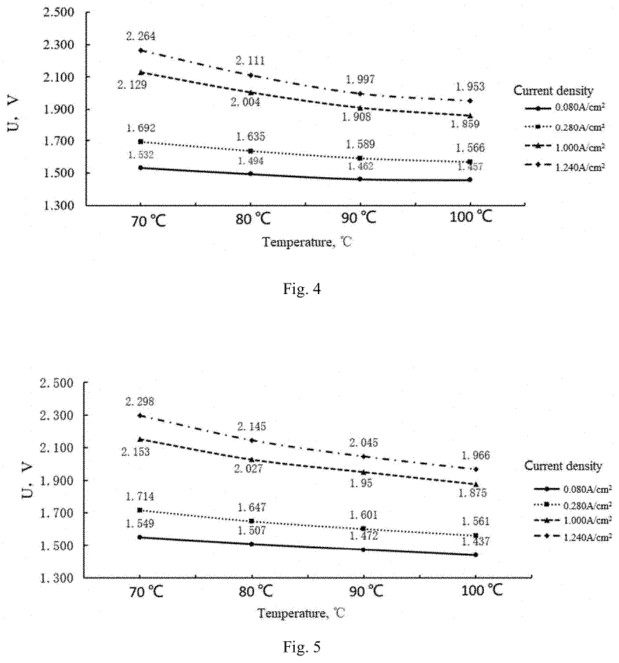

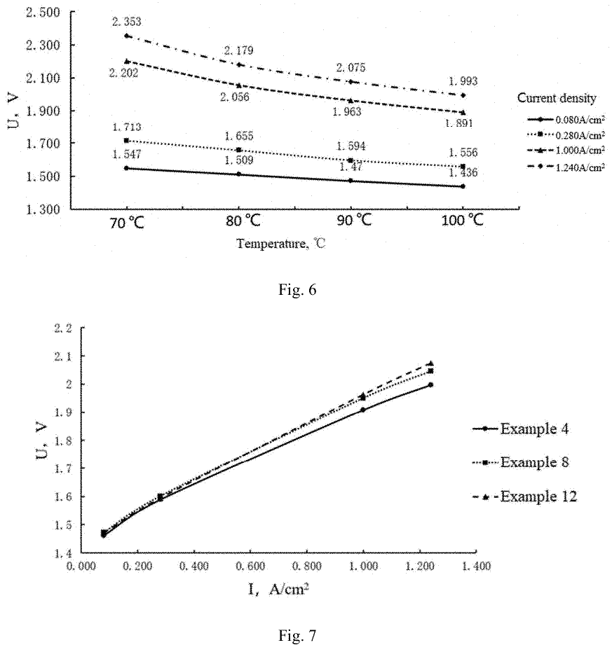

According to conditions in Examples 2-13, the system was operated at different current densities, voltage values were recorded, and graphs of a relation between U and temperature (T) at different current densities (I) shown in FIGS. 4-6 were obtained by means of plotting. FIGS. 4-6 show that for 3 mol/L, 5 mol/L and 7.5 mol/L NaOH solutions, as the operating temperature is increased, the voltage tends to be stable at a relatively low current; the operating temperature is preferably 90-100° C., at which the voltage is relatively low. At a high current density, the temperature rise has a large positive effect on the electrolysis cell, which works at a very high temperature due to sufficient waste heat; at a low current density, however, the temperature rise has a less positive effect on the electrolysis cell, and a small additional loss is caused when the temperature is decreased.

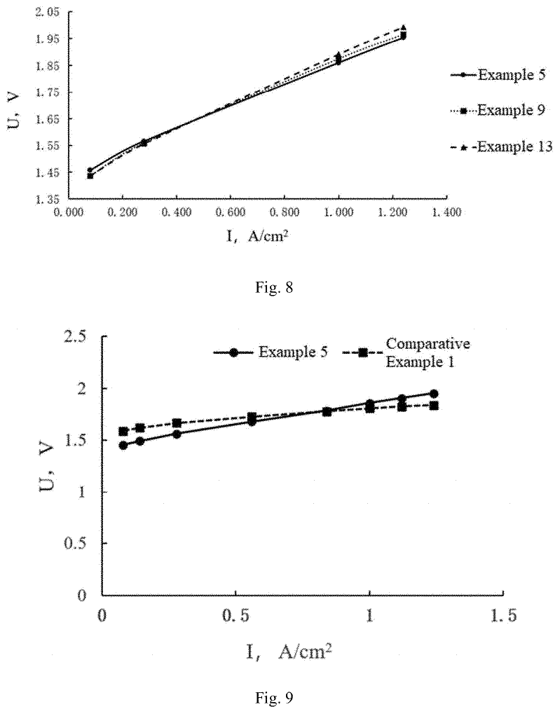

According to conditions in Examples 4, 8 and 12, the system was operated at different current densities, voltage values were recorded, and a U/I curve at different NaOH concentrations shown in FIG. 7 was obtained by means of plotting. According to conditions in Examples 5, 9 and 13, a U/I curve at different NaOH concentrations shown in FIG. 8 was obtained by means of plotting. FIGS. 7-8 show that electrolysis at 90-100° C. and a low current density does not result in a relatively large voltage; a NaOH solution at a lower concentration generates a smaller voltage. Therefore, low concentrations are preferred. Nevertheless, if the temperature is increased to 120° C. or above, a low-concentration solution will boil under a relatively high operating pressure; a high-concentration solution, however, will not boil.

According to conditions in Example 5 and Comparative example 1, the system was operated under different currents, voltage values were recorded, and a U/I curve shown in FIG. 9 was obtained by means of plotting. FIG. 9 shows that, at a low current density, the 3 mol/L NaOH solution has a smaller voltage at 100° C. than 60° C. as the operating temperature of PEM electrolysis, and the membrane is more durable with a longer service life and safer in an alkaline solution than in acidic form. When renewable energy is used to supply power to the electrolysis cell, a smaller voltage means higher hydrogen preparation efficiency.

What is claimed is:

1. An electrolysis cell system, comprising:
an anode chamber with an inlet and an outlet;
a cathode chamber with an inlet and an outlet;
a composite membrane electrode set between the anode chamber and the cathode chamber, which includes a cation exchange membrane in alkali-ion form with an anode catalyst coated on one side thereof and a cathode catalyst coated on the other side thereof;
a continuous or intermittent flow of an aqueous alkaline electrolyte through the anode chamber and the cathode chamber.

2. The electrolysis cell system according to claim 1, wherein the cation exchange membrane in alkali-ion form is a perfluorinated sulfonic acid membrane in alkali-ion form.

3. The electrolysis cell system according to claim 2, wherein the cation exchange membrane in alkali-ion form is a perfluorinated sulfonic acid membrane in potassium-ion form.

4. The electrolysis cell system according to claim 2, wherein the cation exchange membrane in alkali-ion form is a perfluorinated sulfonic acid membrane in sodium-ion form.

5. The electrolysis cell system according to claim 1, wherein a thickness of the cation exchange membrane in alkali-ion form is 8-170 μm; and
the equivalent weight of the cation exchange membrane in alkali-ion form is 700-1,500.

6. The electrolysis cell system according to claim 5, wherein the thickness of the cation exchange membrane in alkali-ion form is 15-60 μm.

7. The electrolysis cell system according to claim 6, wherein the thickness of the cation exchange membrane in alkali-ion form is 50 μm; and
the equivalent weight of the cation exchange membrane in alkali-ion form is 900-1,100.

8. The electrolysis cell system according to claim 1, wherein the anode catalyst comprises transition metals.

9. The electrolysis cell system according to claim 1, wherein the anode catalyst comprises one or more of Mn, Fe, Co, Ni and Cu.

10. The electrolysis cell system according to claim 1, wherein the cathode catalyst is a nickel catalyst.

11. The electrolysis cell system according to claim 1, wherein the cathode catalyst is a Pt/C catalyst and a loading of the Pt/C catalyst is 0-0.25 mg/cm²

12. The electrolysis cell system according to claim 1, wherein the aqueous alkaline electrolyte is an alkali metal hydroxide solution.

13. The electrolysis cell system according to claim 1, wherein the aqueous alkaline electrolyte is a KOH aqueous solution.

14. The electrolysis cell system according to claim 1, wherein the aqueous alkaline electrolyte is a NaOH aqueous solution.

15. The electrolysis cell system according to claim 14, wherein an inlet concentration of the NaOH aqueous solution is 1-15 mol/L.

16. The electrolysis cell system according to claim 14, wherein an inlet concentration of the NaOH aqueous solution is 2.5-4 mol/L.

17. A method for preparing hydrogen and oxygen, wherein, the electrolysis cell system according to claim 1 is used to prepare hydrogen and oxygen by electrolysis, wherein hydrogen is discharged from the cathode chamber outlet, and oxygen is discharged from the anode chamber outlet.

18. The method for preparing hydrogen and oxygen according to claim 17, wherein the aqueous alkaline electrolyte is fed by the following method:
mixing the aqueous alkaline electrolyte flowing out from the anode chamber outlet and the aqueous alkaline electrolyte flowing out from the cathode chamber outlet to obtain a mixed solution; and
passing the mixed solution into the anode chamber inlet and the cathode chamber inlet respectively, to enter the anode chamber and the cathode chamber.

19. The method for preparing hydrogen and oxygen according to claim 17, wherein the aqueous alkaline electrolyte is fed by the following method:
passing the aqueous alkaline electrolyte flowing out from the anode chamber outlet into the cathode chamber inlet to enter the cathode chamber; and
passing the aqueous alkaline electrolyte flowing out from the cathode chamber outlet into the anode chamber inlet to enter the anode chamber.

20. The method for preparing hydrogen and oxygen according to claim 17, wherein the operating temperature of the electrolysis cell system is 80-150° C.
